(19) United States
(12) Patent Application Publication
(10) Pub. No.: US 2026/0137998 A1
(43) Pub. Date: May 21, 2026

(54) SYSTEM AND METHOD FOR CONDUCTING RAFFLES

(71) Applicant: Nicholas DAVIDSON, Regents Park (AU)

(72) Inventor: Nicholas DAVIDSON, Regents Park (AU)

(21) Appl. No.: 19/119,423

(22) PCT Filed: Oct. 6, 2023
(86) PCT No.: PCT/AU2023/050986

§ 371 Date: Apr. 9, 2025

(30) Foreign Application Priority Data
Oct. 10, 2022 (AU) 2022902948

(51) Int. Cl. A63F 3/08; G06Q 30/0241; G06Q 30/0283; G06Q 30/0601

(52) U.S. Cl. CPC A63F 3/081; G06Q 30/0277; G06Q 30/0283; G06Q 30/0623; G06Q 30/0641; A63F 2003/088

(57) ABSTRACT

A computer-implemented method for conducting raffles including receiving details from a first registered user regarding a raffle, including a description of a prize for which raffle tickets are offered for purchase by one or more second registered users and a price for the prize, prompting selection of a proposed raffle end date and one or more ticket distribution option(s), each ticket distribution option involving a different number of tickets prior to the proposed raffle end date, associating the selected ticket distribution option(s) with the proposed raffle and based upon the item details and selected ticket distribution option(s), automatically generate a raffle interface accessible by second registered users, the interface providing details relating to the proposed raffle and one or more raffle ticket purchasing option(s) selected by the first registered user and manage the purchasing of tickets for the proposed raffle according to the ticket distribution option(s) associated with the raffle.

### FIELD OF THE INVENTION

The present invention relates to a computer implemented system and method that provides a centralized platform for conducting raffles in respect of products and/or services (for example, new or used items) or prize items (for example, cash prizes) rather than conducting raffles on a number of disparate computer systems.

### BACKGROUND OF THE INVENTION

A raffle is a means of raising money by selling tickets, one or some of which are subsequently drawn at random, with the holder (or holders) of such drawn tickets winning a prize. To enter a raffle and therefore be eligible to win a prize, an individual may elect to purchase a single raffle ticket, or may elect to purchase multiple tickets to increase their prospects of winning.

Since raffles are essentially a gambling event, they are often regulated and organisers are required to abide by the regulations according to the laws of the state or country in which they reside. For example, in the state of Victoria, Australia, an organisation that benefits from a proposed raffle is required to be “Declared” by the Victorian Gambling and Casino Control Commission (VGCCC) in order to conduct a raffle of any size.

Raffles have traditionally been conducted by issuing paper tickets in exchange for cash funds that cover the specified cost of a ticket. There are a number of methods for disseminating paper tickets including selling paper tickets door to door, using storefronts (local retailers) to post flyers and/or sell tickets on the organiser's behalf, printing advertisements regarding a proposed raffle, establishing booths in local shopping centres or in public spaces in which paper tickets are offered for sale, or organizing a fundraising event. The issuance of paper tickets requires the organiser to create/print or buy pre-made tickets that each include a detachable “stub” side that is usually numbered and that contains the organisation name, address, phone number, event name, draw date and any other relevant information such as a website of the organisation. The opposite side of the ticket (retained by the raffle organiser) will also include the same number as the detachable stub side and spaces in which a raffle participant completes with their name and contact details. Upon issuance of one or more tickets, the raffle organiser, or a representative of the raffle organiser, collects funds from the raffle participant to cover the cost of the purchased ticket(s). For obvious reasons, conducting raffles in paper-ticket form, and collection of funds in the form of cash presents a number of potential issues, particularly in the event tickets and/or funds are lost or stolen.

To ameliorate issues associated with paper-ticket raffles, many organisations now prefer to conduct raffles in an online environment, usually by establishing a specific website for their raffle in which the raffle details are listed online and tickets in electronic form are offered for sale. Funds are also received electronically. Accordingly, such platforms significantly reduce the risk of tickets and/or funds being lost or stolen.

However, known platforms only cater for individual raffles (eg. each raffle platform relating to a specific field such as charity, school, sporting, etc.) rather than catering for different types of raffles in a single platform. This results in wastage of time on the part of users who are required to register with multiple different platforms to access different raffles, as well as wastage of computer processor, network and memory resources associated with same such arrangements.

The present invention seeks to mitigate the problems discussed herein, or at least seeks to provide an alternative solution to existing systems and methods for hosting and participating in a raffle.

The reference to any prior art in this specification is not, and should not be taken as, an acknowledgement or any suggestion, that the prior art forms part of the common general knowledge.

### SUMMARY OF THE INVENTION

In one aspect, the present invention provides a computer-implemented system for a computer-implemented method for conducting raffles, the method including receiving, by one or more processors, details from a first registered user in relation to a proposed raffle, the details including a description of a prize in respect of which raffle tickets are offered for purchase by one or more second registered users, and a price associated with the prize, prompt, by the one or more processors, the first registered user to select: a proposed raffle end date, and one or more ticket distribution option(s) from a plurality of different ticket distribution options, each ticket distribution option involving a different number of tickets available for purchase prior to the proposed raffle end date, associate, by the one or more processors, the one or more selected ticket distribution option(s) with the proposed raffle, and based upon the item details and the selected ticket distribution option(s), automatically generate, by the one or more processors, a raffle interface accessible by the one or more second registered users, the interface providing details relating to the proposed raffle and the one or more raffle ticket purchasing option(s) based upon the ticket distribution option(s) selected by the first registered user, and manage, by the one or more processors, the purchasing of tickets for the proposed raffle by the one or more second registered users according to the ticket distribution option(s) associated with the raffle.

In an embodiment, the first registered user is the raffle initiator and the one or more second registered users are individuals seeking to attain the raffle prize. The raffle prize may include, but is not limited to, any one or more of a new or used item or good (for example a hamper or an automobile), an experience (for example, a hot air balloon ride or a tickets to a concert), a holiday, a hotel stay or a cash prize.

In an embodiment, each raffle ticket purchasing option may include a raffle ticket purchase price, wherein the purchase price may be automatically generated according to the ticket distribution option selected by the first registered user and/or the raffle end date.

As an example, a first raffle ticket distribution option may include an option which only allows a limited number of tickets to be sold (eg. a raffle offering a winning prize of $15,000 and providing a limited number of 15 raffle tickets to be made available for purchase at $1000 per ticket), and at least one further ticket distribution option which allows for unlimited tickets to be sold, with financial incentive provided to sell more tickets (eg. a raffle offering an item worth $500 may cause 100 tickets to be made available for purchase at $5 per ticket, and funds received in respect of each additional ticket sold beyond the first 100 representing profits for further distribution (eg. to the raffle initiator, a charity of their choosing, and/or an administrator of the platform).

Accordingly, in an embodiment, managing the purchasing of tickets for the raffle may include limiting the number of tickets available for purchase such that only a limited number of tickets are sold until funds substantially equivalent to the price for the item have been raised, irrespective of there being additional time before the raffle end date.

An alternative and/or additional embodiment may include managing the purchasing of tickets for the raffle by detecting when a first tranche of tickets sufficient to cover the price for the item have been sold, and subsequently making a second tranche of tickets available for purchase until the raffle end date.

In an embodiment, managing the purchasing of tickets for the raffle may further include causing funds received from the one or more second registered users who have purchased tickets to be transferred to a bank account associated with the first registered user.

In an embodiment, the method may involve making available for purchase two or more different tranches of tickets. In an embodiment, the method may include first and second tranches of tickets, and causing funds received in respect of the first tranche to be processed differently as compared with funds received in respect of the second tranche, where funds received in respect of the first tranche are automatically allocated to the first registered user (raffle initiator), funds received in respect of the second tranche (representing profits in respect of the raffle) are automatically distributed according to a predetermined profit distribution rule. As an example, a profit distribution arrangement may include: 40% to the raffle initiator, 50% to an administrator of the platform, and 10% to a charity selected by the raffle initiator.

In an embodiment, where a raffle ceases on the proposed raffle end date, the raffle is automatically drawn and the second registered user associated with the winning ticket attains the raffle prize.

In an embodiment, the method may further include validating the price for the item allocated by the first registered user as representative of a fair market value for the item.

In an embodiment, the method may further include prompting the first registered user to select a raffle start date.

In another aspect, the present invention provides a computer-implemented system for conducting raffles, the system including one or more processors operable to receive details from a first registered user in relation to a proposed raffle, the details including a description of a prize in respect of which raffle tickets are offered for purchase by one or more second registered users, and a price associated with the prize, prompt the first registered user to select a proposed raffle end date, and one or more ticket distribution option(s) from a plurality of different ticket distribution options, each ticket distribution option involving a different number of tickets available for purchase prior to the proposed raffle end date, associate the one or more selected ticket distribution option(s) with the proposed raffle, and based upon the item details and the selected ticket distribution option(s), automatically generate a raffle interface accessible by the one or more second registered users, the interface providing details relating to the proposed raffle and the one or more raffle ticket purchasing option(s) based upon the ticket distribution option(s) selected by the registered first user, and manage the purchasing of tickets for the raffle by the one or more second registered users according to the ticket distribution option(s) associated with the raffle.

It will be appreciated that the system of the present invention provides a platform that represents a single centralised system upon which a plurality of different raffle initiators, each potentially having a different preference with respect to how tickets should be distributed (offered for sale), may initiate new raffles and select their preferred raffle ticket distribution option. The system of the present invention therefore seeks to address problems associated with known platforms which only cater for individual raffles (e.g. raffles relating to specific fields such as charity, school, sporting, etc., rather catering for all in a single platform), and which therefore results in wastage of time on the part of users who are required to register with multiple different platforms to access different raffles, as well as wastage of computer processor, network and memory resources associated with same.

In a further aspect, the present invention provides a computer-readable medium including computer instruction code that, when executed on a computer, causes one or more processors of the computer to perform the steps of receiving, by the one or more processors, details from a first registered user in relation to a proposed raffle, the details including a description of a prize in respect of which raffle tickets are offered for purchase by one or more second registered users, and a price associated with the prize, prompting, by the one or more processors, the first registered user to select: a proposed raffle end date, and one or more ticket distribution option(s) from a plurality of different ticket distribution options, each ticket distribution option involving a different number of tickets available for purchase prior to the proposed raffle end date, associating, by the one or more processors, the one or more selected ticket distribution option(s) with the proposed raffle, and based upon the item details and the selected ticket distribution option(s), automatically generating, by the one or more processors, a raffle interface accessible by the one or more second registered users, the interface providing details relating to the proposed raffle and the one or more raffle ticket purchasing option(s) based upon the ticket distribution option(s) selected by the first registered user, and managing, by the one or more processors, the purchasing of tickets for the proposed raffle by the one or more second registered users according to the ticket distribution option(s) associated with the raffle.

### BRIEF DESCRIPTION OF THE DRAWINGS

Embodiments of the invention will now be described in further detail with reference to the accompanying Figures in which:

FIG. 1 provides an overview of a system according to an embodiment of the present invention showing, in particular, the interaction of various system components;

FIG. 2 illustrates a diagram associated with an exemplary server component of the system illustrated in FIG. 1;

FIG. 3 illustrates an exemplary flow diagram of a process that enables users to download and install a software application, and subsequently access, or register to use, the software application for interaction with the system illustrated in FIG. 1;

FIG. 4 illustrates an exemplary flow diagram of a process that enables a user seeking to initiate a raffle to upload details regarding the raffle, including details relating to the raffle item(s) and the user's preference regarding how raffle tickets are to be distributed;

FIG. 5 illustrates an exemplary flow diagram of a process that enables a user seeking to purchase raffle tickets to search for raffles by category, select a raffle of interest, and subsequently purchase one or more raffle tickets according to the ticket distribution preference(s) specified by the raffle initiator;

FIG. 6 illustrates an exemplary flow diagram of a process that enables one or more raffle winners to be declared, and that further enables the raffle item(s) to be claimed by the raffle winners; and

FIG. 7 illustrates an exemplary flow diagram of a process that enables additional application functionality, including a goods/service advertisement and purchasing facility, chat functionality and a reward/token facility.

### DETAILED DESCRIPTION OF EMBODIMENT(S) OF THE INVENTION

For simplicity and illustrative purposes, the present disclosure is described by referring to embodiment(s) thereof. In the following description, numerous specific details are set to forth to provide a better understanding of the present disclosure. It will be readily apparent, however, that the current disclosure may be practiced without limitation to the specific details. In other instances, some methods and structures have not been described in detail to avoid obscuring the present disclosure.

The present invention relates to a computer-implemented system and method for conducting raffles. In the particular embodiment(s) described, the system and method provide a platform that hosts a computer-executable software application (40), wherein the application (40) is accessible by a plurality of registered users (30), including raffle initiators (30A) and other registered users (30B) seeking to purchase raffle tickets (70) in an effort to obtain one or more raffle items (60). In particular, the system utilises a central server (20) in communication with data communication devices (50) associated with each user (30).

It will be appreciated that general reference to user (30) herein is intended to reference either one or both users (30A) and (30B).

The central server (20) maintains one or more processors and/or databases for performing functions, including receiving details from a raffle initiator (30A) in relation to a proposed raffle, the details including a description of one or more raffle items (60) in respect of which raffle tickets (70) are offered to one or more registered users (30B) for purchase, and a price associated with the one or more raffle items (60). The central server (20) subsequently prompts the raffle initiator (30A) to select a proposed raffle end date, and one or more ticket distribution options from a plurality of different ticket distribution options, wherein each option involves a different number of tickets (70) available for purchase prior to the proposed raffle end date. Based upon the selection by the raffle initiator (30A), the selected ticket distribution option(s) are associated with the proposed raffle such that when any user (30B) selects the particular raffle only the selected ticket distribution option(s) are available to users (30B).

Based upon the raffle item details and the selected ticket distribution option(s), a raffle interface (190) which is accessible by registered users (30B) seeking to purchase raffle tickets (70), is generated. The interface (190) provides details relating to the proposed raffle as well as the one or more raffle ticket purchasing options based upon the ticket distribution option(s) selected by the raffle initiator (30A). In this way, the purchasing of tickets for the proposed raffle may be managed according to the ticket distribution option(s) selected by the raffle initiator (30A).

Skilled readers will appreciate that the result is a centralized platform for conducting raffles in respect of products and/or services (e.g. new or used items such as a hamper or automobile), an experience (e.g. a hot air balloon ride or tickets to a concert), a holiday, a hotel stay, cash prize, etc, wherein different raffle ticket distribution options are available for selection by a raffle initiator (30A). Accordingly, the platform represents a single centralized system upon which a plurality of different raffle initiators (30A), each potentially having a different preference regarding how tickets should be distributed (offered for sale to users (30B)), may initiate new raffles and select their preferred raffle ticket distribution option. This addresses a technical problem associated with known platforms which are only capable of catering for individual raffles (e.g. raffles relating to specific fields such as charities, schools, sporting clubs, etc) rather than catering for all in a single platform, which causes a wastage of time on the part of users who are required to sign in to multiple different platforms to access different raffles, and wastage of computer processor, network and memory resources associated with a replication of resources to host the different raffles.

It will also be appreciated that having a single centralized system upon which a plurality of different raffle initiators may initiate new raffles avoids the requirement for such users to adopt separate (multiple) systems for performing online raffles. The arrangement according to the present invention will substantially reduce electrical energy consumption, computing and networking requirements, and conserve bandwidth usage. Similarly, having a single centralized system upon which a plurality of raffles may be performed enables users seeking to purchase raffle tickets to search for one or more raffles of interest in a single system, and hence, the requirement for such users to access separate (multiple) systems for performing online raffles. This will also substantially reduce electrical energy consumption, computing and networking requirements, and conserve bandwidth usage as would otherwise occur when operating a number of raffles on disparate computer systems.

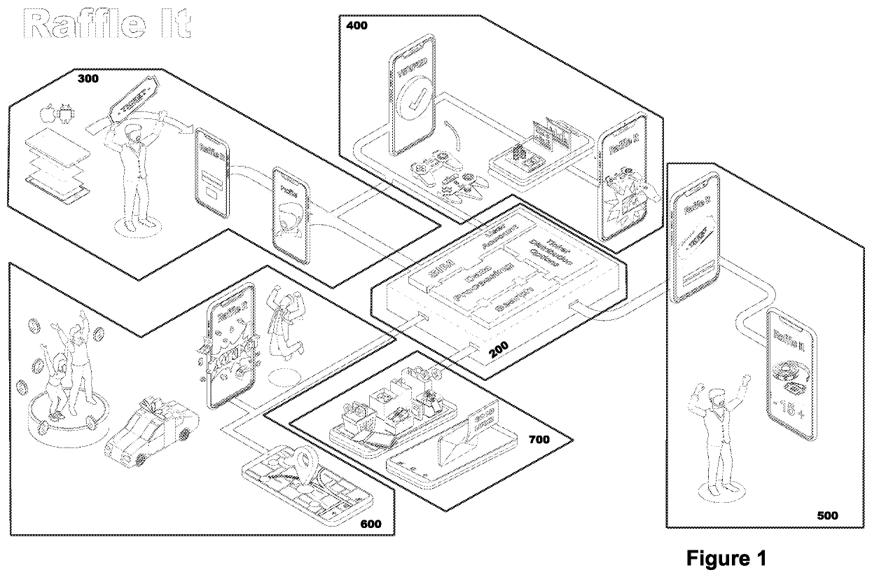

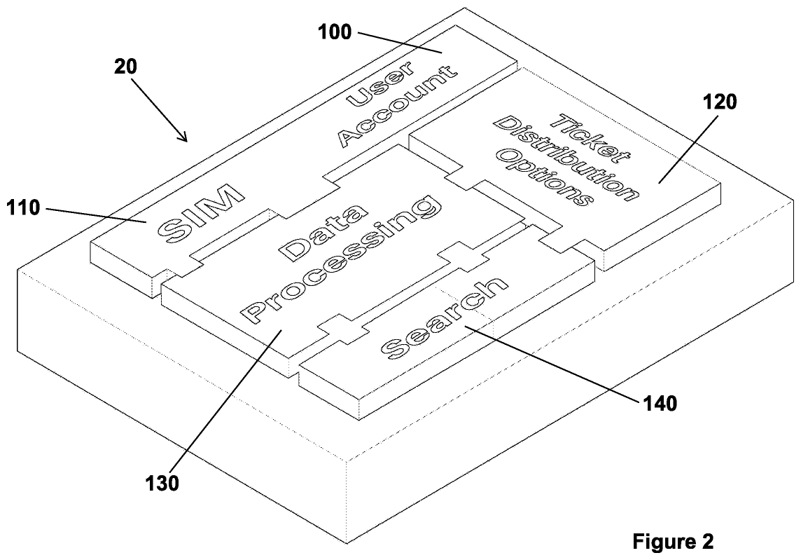

FIG. 1 is divided into segments which are further expanded in subsequent FIGS. 2-7. In particular, Segment 200 of FIG. 1 shows the server component (20) with which the software application (40) operating on data communication devices (50) are configured to communicate. It will be apparent to the person skilled in the relevant field of technology that the software application (40) may be a mobile application or a web application and that, similarly, the data communication device (50) utilised by users (30) may be a mobile device or computer device. The server component (20) is additionally detailed in FIG. 2.

The skilled person will appreciate that the steps described herein may be executed by the devices (50), wherein such operations are facilitated by the software application (40) operating on each device. According to another implementation of the present invention, the server (20) is programmed to provide all of the functions described herein where they cannot be provided locally on the user devices (50), or where it may be commercially of practically infeasible to implement such a configuration. In other words, the steps described herein as performed by the device (50), or components of the device (50) that are described as implementing the invention, may be associated with hardware that is located externally of the device (50), such as the remote central server (20) for example (ie. in a distributed architecture). Different arrangements are possible in this regard, and alternate variations will be apparent to the person skilled in the relevant field of technology.

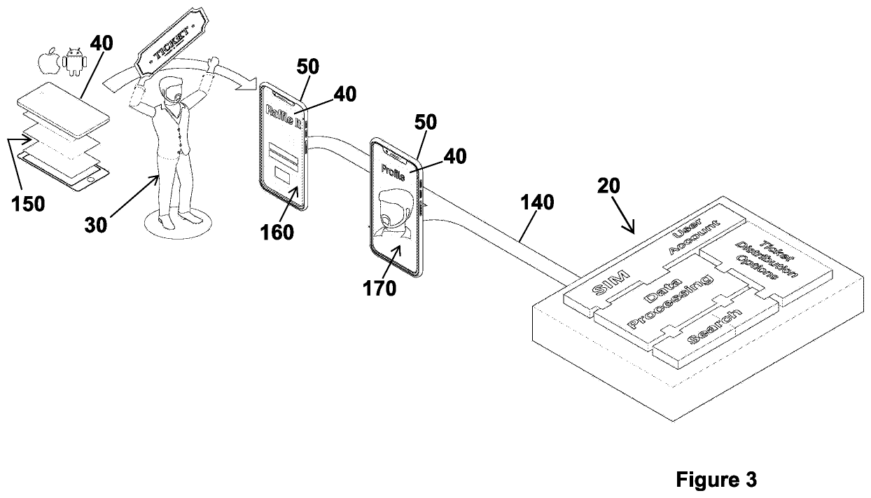

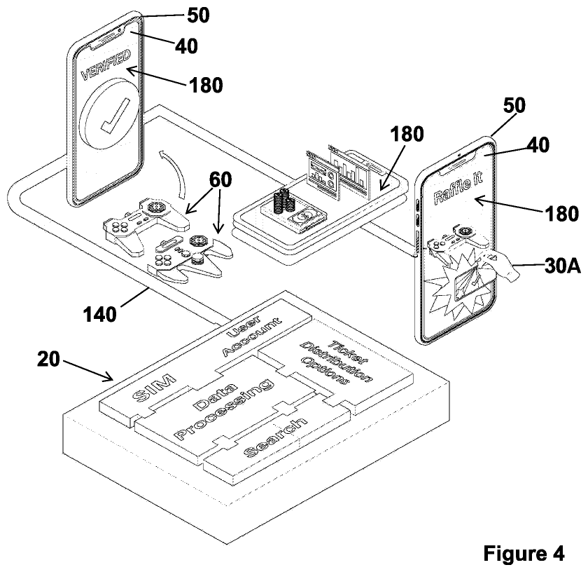

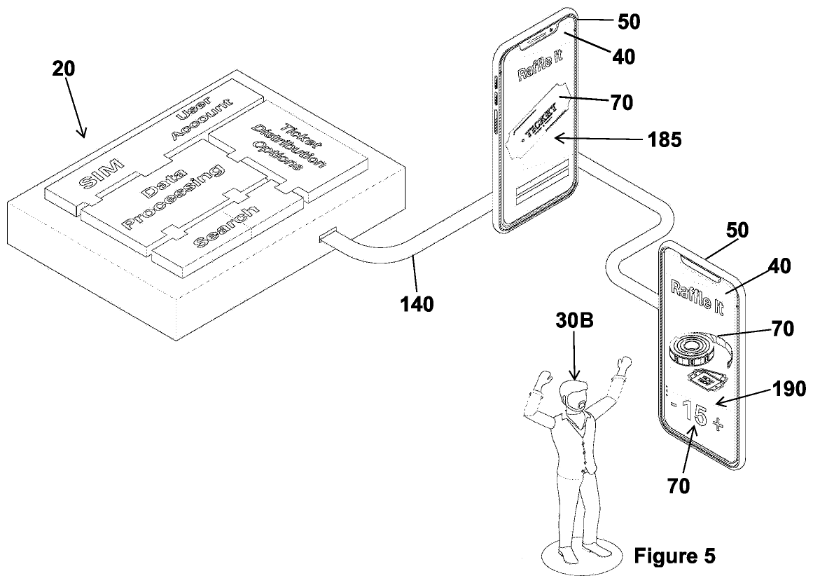

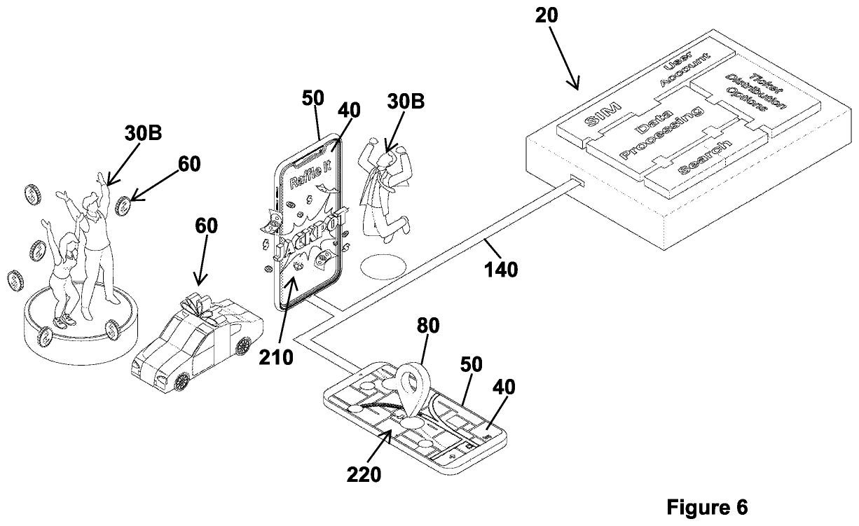

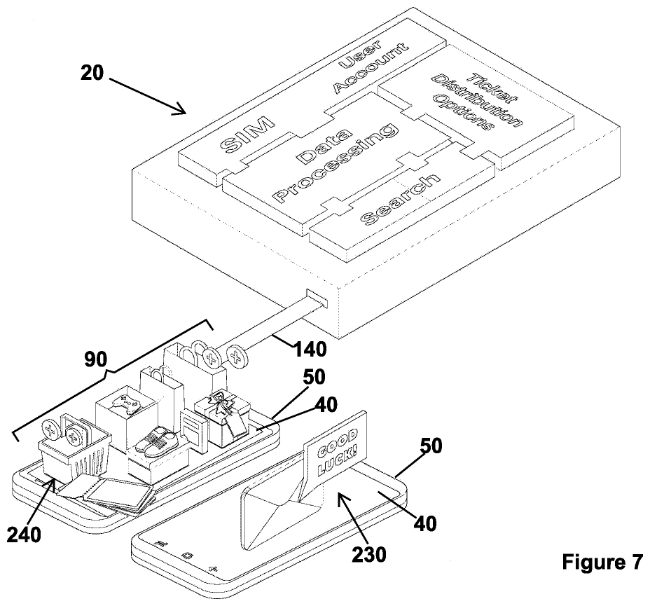

Segment 300 of FIG. 1 shows a user (30) downloading and installing the application (40) and subsequently accessing the application (40) in order to establish an account and user profile, as further detailed in FIG. 3. Segment 400 of FIG. 1 illustrates how a proposed new raffle may be initiated by a user (30A), as further detailed in FIG. 4. Segment 500 of FIG. 1 illustrates how other registered users (30B) may utilise the raffle interface (190) to purchase raffle tickets (70) according to the ticket distribution option(s) specified by the raffle initiator (30A), which is further detailed in FIG. 5. Segment 600 of FIG. 1 illustrates the declaration of a winner in respect of a particular raffle, and the subsequent delivery of raffle items (60), as detailed in FIG. 6. Finally, Segment 700 of FIG. 1 illustrates additional functionality of the software application including a goods/service advertisement facility, chat functionality and a reward/token facility, as further detailed in FIG. 7.

As mentioned above, FIG. 2 shows in greater detail Segment 200 of FIG. 1 and, in particular, FIG. 2 shows the server component (20) which includes infrastructure upon which the platform of the present invention operates. The infrastructure may be local or cloud-based.

The central server (20) may operate one or more computer processors and maintain one or more databases to enable the following functionality and/or storage:
User account register (100) storing user details such as name, age, address, contact details, identifies such as driver's licenses or passport details, and any additional data which may be relevant for the purpose of identifying each user (30). Register (100) may also store data relating to each user (i.e. raffle initiators (30A) and raffle ticket purchasers (30B)), including details relating to raffle items, raffle start and end dates, user preferences, profit distribution rules, historical raffle outcomes, etc;
Security information management (SIM) which ensures the safety of user data and which may be utlilised to verify user data using identification verification services, including, where necessary, prompting users (30) to provide additional data such as an image of themselves or further identity verification;
Ticket distribution options database (120) storing ticket distribution options available for selection by raffle initiators (30A), as well as those actually selected for particular raffles, wherein the database (120) may be in the form of a data structure which identifies the relationship between particular users (30), particular raffles, and the particular ticket distribution options selected for each raffle by raffle initiators (30A). This enables the subsequent location and retrieval of such information to be more efficient, where such retrieval may occur in substantially real-time;
Data processing functionality (130) for associating selected ticket distribution options with particular raffles created by users (30A), generating raffle interfaces (such as interface 190), managing the purchase of tickets (70) by users (30B) according to the ticket distribution option(s) selected for particular raffles, and managing the transfer of raffle funds according to selected profit distribution rule(s);
Search functionality (135) enabling users (30B) to conduct searches for raffles (e.g. by category), as well as searching for goods and/or services that are available for purchase which may be advertised to registered users (30) according to their interaction with the platform.

FIG. 2 also depicts that server (20) is configured to enable communication (140) with the user devices (50) and, in particular, the software applications (40) operating on each device (50). Such communications may occur via the internet or similar network.

FIG. 3 shows in greater detail Segment 300 of FIG. 1 and, in particular, the steps associated with a user (30) installing the application (40) which may be achieved by downloading the application (40) from an application store. Each user (30) may create an account using the application (40) and the account information may be stored in the account register (100). As described above, the account register (100) may capture information sufficient to enable each user (30) to be correctly identified.

The process of installing the application (40) is indicated by arrow (150), and interface (160) is also shown which allows each user (30) to download and install the application (40) in order to access the functionality thereof, including to create and maintain a user profile as shown in interface (170). In other words, once the application (40) has been accessed by a user (30), the user (30) may be presented with an interface, identical or similar to interface (170), to allow the user (30) to create and maintain a profile and be provided with the ability/edit profile details. Once sufficient information is provided by the user (30) and verified, the user (30) will be successfully registered such that the user (30) becomes a registered user who may then utilise the functionality of the application (40), which may be in accordance with a subscription level of the user (30).

FIG. 4 shows in greater detail Segment 400 of FIG. 1 and, in particular, the use of the application (40) by a raffle initiator (30A) to create a proposed raffle by providing a description of one or more raffle items (60) in respect of which raffle tickets (70) will be offered for purchase, as well as a price associated with the one or more raffle items (60). The raffle initiator (30A) may also be prompted to select a raffle start date, a raffle end date, and one or more ticket distribution options to make available to registered users (30B) seeking to purchase raffle tickets (70). Each raffle ticket purchasing option may include a predetermined raffle ticket purchase price and in this regard, the purchase price may be automatically generated according to the ticket distribution option(s) selected by the raffle initiator (30A) and/or the raffle end date.

In one example, a first raffle ticket distribution option may include an option which only allows a limited number of tickets to be sold (eg. a raffle offering a winning prize of $15,000 and providing a limited number of 15 raffle tickets to be made available for purchase at $1,000 per ticket). According to an alternative ticket distribution option, unlimited tickets may be made available for sale, with financial incentive provided to the raffle initiator (30A) to sell more tickets (eg. a raffle offering an item worth $500 may cause 100 tickets to be made available for purchase at $5 per ticket, and funds received in respect of each additional ticket sold beyond the first 100 representing profits for further distribution such as to the raffle initiator, a charity of their choice, and/or administrator of the platform). All of these details may be entered using the raffle creation interfaces (180) shown in FIG. 4.

The price for a raffle item (60), when indicated by a raffle initiator (30A), may also be validated to ensure that the price for the raffle item (60) is representative of a fair market value for the item (60).

FIG. 5 shows in greater detail Segment 500 of FIG. 1, and, in particular, the use of the application (40) by users (30B) to access a search interface (185) in order to locate a particular raffle of interest, and a raffle interface (190) which enables the user (30B) to purchase raffle tickets (70) according to the one or more ticket distribution options available to the user (30B) in accordance with the particular distribution option(s) selection by the raffle initiator (30A).

Searching may be undertaken through interface (185) according to any suitable searching criteria, including by keyword in relation to raffle category. For example, a user (30B) may be interested in raffles pertaining to a particular category of raffle item (60), and a key word search in respect of such items may be conducted via interface (185). In another example, a user (30B) may only be interested in raffles conducted in a particular location, and hence the search results presented to user (30B) may include solely those raffles conducted at specified location or within a predetermined vicinity of the location. Any number of categories may be utilised in support of the search functionality provided by interface (185), to facilitate the process of searching for and locating raffles.

Once a raffle of interest is located, the raffle interface (190) may be automatically generated, and wherein the ticket allocation through interface (190) may be automatically managed in accordance with the relevant ticket distribution option(s) selected by the raffle initiator (30A). According to the example described earlier in which a limited number of 15 raffle tickets are to be made available for purchase, the interface (190) may manage the purchasing of tickets for the particular raffle by limiting the number of tickets available for purchase to 15. When the limited number of tickets are all sold, the interface (190) may provide a relevant notification to that effect to all registered users (30B) seeking to access the particular raffle for the purpose of purchasing tickets. Accordingly, in this embodiment, managing the purchase of tickets through interface (190) involves limiting the number of tickets available for purchase such that only a limited number of tickets are made available for sale. In this regard, the number of tickets made available and the price of the tickets may be based upon the price for the item such that when all tickets are sold, funds substantially equivalent to the price for the item will have been raised (irrespective of any additional available time before a raffle end date).

In the subsequent example described above where an unlimited number of tickets are offered for purchase, managing the purchase of tickets through interface (190) may involve detecting when a first tranche of tickets sufficient to cover the price for the item (60) has been sold, and subsequently making a second tranche of tickets available for purchase until the raffle end date. In this embodiment, funds received in respect of the first tranche may be processed differently as compared with funds received in respect of the second tranche of tickets. For example, funds received in respect of the first tranche may be automatically allocated to the raffle initiator (30A), whereas funds received in respect of the second tranche (representing profits in respect of the raffle) may be automatically distributed according to a predetermined profit distribution arrangement. As an example, a profit distribution rule may include 40% to the raffle initiator (30A), 50% to the administrator of the platform, and 10% to a charity selected by the raffle initiator (30A). However, the present invention is not limited to any one particular profit distribution rule, and such rules may be selected by raffle initiators (30A) and/or platform administrators.

Once a raffle ticket (60) is purchased by a registered user (30B), the user (30B) may be prompted to transfer funds from their own bank account to a bank account associated with the raffle initiator (30A), and such financial transactions may also be managed utilising the functionality of the software application (40), or by other suitable means.

FIG. 6 illustrates in greater detail Segment 600 of FIG. 1 and, in particular, the ceasing of a raffle on a proposed raffle end date, wherein the raffle is drawn and one of a plurality of registered users (30B) who purchased tickets in respect of the raffle will be announced (e.g. through interface (210)) as a winner of the particular raffle item(s) (60). The application (40) may also enable the winner to make arrangements to obtain the raffle item (60) or prize. In this regard, the software application (40) may facilitate the process of delivery and/or picking up of the raffle item (60) by providing an interactive map to the winner indicating a pick up location (80) for the prize. Alternatively, the interactive map may be utilized by the raffle winner to indicate a location (80) to which the raffle item (60) is required to be delivered (e.g. a physical address of the winner).

FIG. 7 shows in greater detail Segment 700 of FIG. 1 and, in particular, additional example interfaces (230) and (240) associated with software application (40). Interface (230) represents a chat interface that enables registered users (30B), raffle initiators (30A) and also platform administrators to engage in online discussion. For example, particular registered users (30B) who have each purchased raffle tickets in respect of the same raffle may have similar interests and hence prefer to engage in chat with other like-minded registered users (30B). In another example, a registered user (30B) may prefer to seek additional information relating to a particular raffle and hence may elect to engage in a message exchange with a raffle initiator (30A).

The platform may also gather data from registered users (30A) and (30B) and create detailed profiles of each user as they interact with the platform, wherein such data may then be utilised to promote customized offers to users including advertising goods and/or services as shown in interface (240). Furthermore, participation in raffles may result in rewards/tokens being provided to particular registered users (30B) who may then utilise same in order to claim additional prizes and/or discounts in relation to offered goods and/or services.

It will be appreciated by persons skilled in the relevant field of technology that numerous variations and/or modifications may be made to the invention as detailed in the embodiments without departing from the spirit or scope of the invention as broadly described. The present embodiments are, therefore, to be considered in all aspects as illustrative and not restrictive.

Throughout this specification and claims which follow, unless the context requires otherwise, the word “comprise”, and variations such as “comprises” and “comprising”, will be understood to imply the inclusion of a stated feature or step, or group of features or steps, but not the exclusion of any other feature or step or group of features or steps.

1. A computer-implemented method for conducting raffles, the method comprising:
receiving, by one or more processors, details from a first registered user in relation to a proposed raffle, the details comprising:
a description of a prize in respect of which raffle tickets are offered for purchase by one or more second registered users; and
a price associated with the prize;
prompt, by the one or more processors, the first registered user to select:
a proposed raffle end date; and
one or more ticket distribution option(s) from a plurality of different ticket distribution options, each ticket distribution option involving a different number of tickets available for purchase prior to the proposed raffle end date;
associate, by the one or more processors, the one or more selected ticket distribution option(s) with the proposed raffle; and
based upon the details in relation to a proposed raffle and the selected ticket distribution option(s), automatically generate, by the one or more processors, a raffle interface accessible by the one or more second registered users, the interface providing details relating to the proposed raffle and one or more raffle ticket purchasing option(s) based upon the ticket distribution option(s) selected by the first registered user; and
manage, by the one or more processors, the purchasing of tickets for the proposed raffle by the one or more second registered users according to the ticket distribution option(s) associated with the raffle;
wherein each raffle ticket purchasing option comprises a raffle ticket purchase price where the purchase price is automatically generated according to the ticket distribution option selected by the first registered user and/or the raffle end date; and
the interface comprises search functionality enabling the one or more registered users to conduct searches for raffles and goods and/or services that are available for purchase, wherein the one or more goods and/or services are advertised to the one or more second registered users according to their interaction with the platform.

2. The computer-implemented method of claim 1, wherein the first registered user is the raffle initiator and the one or more second registered users are individuals seeking to attain the raffle prize.

3. The computer-implemented method of claim 1, wherein the raffle prize comprises any one or more of a new or used item or good, an experience, a holiday, a hotel stay or a cash prize.

4. The computer-implemented method of claim 1, wherein managing the purchasing of tickets for the raffle comprises limiting the number of tickets available for purchase such that only a limited number of tickets are sold until funds substantially equivalent to the price of the item have been raised, irrespective of the availability of additional time before the raffle end date.

5. The computer-implemented method of claim 1, further comprising managing the purchasing of tickets for the raffle by detecting when a first tranche of tickets sufficient to cover the price of the item have been sold, and subsequently causing a second tranche of tickets to be available for purchase until the raffle end date.

6. The computer-implemented method of claim 1, wherein managing the purchasing of tickets for the raffle further comprises causing funds received from the one or more second registered users who have purchased tickets to be transferred to a bank account associated with the first registered user.

7. The computer-implemented method of claim 1, further comprising causing the availability of two or more different tranches of tickets for purchase.

8. The computer-implemented method of claim 7, further comprising processing funds received in respect of the first tranche of tickets processed differently as compared with funds received in respect of the second tranche of tickets, where funds received in respect of the first tranche of tickets are automatically allocated to the first registered user and funds received in respect of the second tranche of tickets are automatically distributed according to a predetermined profit distribution arrangement.

9. The computer-implemented method of claim 1, wherein when the raffle ceases on the proposed raffle end date, the raffle is automatically drawn and the second registered user associated with the winning ticket is notified regularly the raffle prize.

10. The computer-implemented method of claim 1, further comprising validating the price for the item allocated by the first registered user as representative of a fair market value for the item.

11. The computer-implemented method of claim 1, further comprising prompting the first registered user to select a raffle start date.

12. A computer-implemented system for conducting raffles, the system comprising one or more processors operable to:
receive details from a first registered user in relation to a proposed raffle, the details comprising:
a description of a prize in respect of which raffle tickets are offered for purchase by one or more second registered users; and
a price associated with the prize;
prompt the first registered user to select:
a proposed raffle end date; and
one or more ticket distribution option(s) from a plurality of different ticket distribution options, each ticket distribution option involving a different number of tickets available for purchase prior to the proposed raffle end date;
associate the one or more selected ticket distribution option(s) with the proposed raffle; and
based upon the item details and the selected ticket distribution option(s), automatically generate a raffle interface accessible by the one or more second registered users, the interface providing details relating to the proposed raffle and the one or more raffle ticket purchasing option(s) based upon the ticket distribution option(s) selected by the registered first user; and
manage the purchasing of tickets for the raffle by the one or more second registered users according to the ticket distribution option(s) associated with the raffle;
wherein each raffle ticket purchasing option comprises a raffle ticket purchase price where the purchase price is automatically generated according to the ticket distribution option selected by the first registered user and/or the raffle end date; and
the interface comprises search functionality enabling the one or more registered users to conduct searches for raffles and goods and/or services that are available for purchase, wherein the one or more goods and/or services are advertised to the one or more second registered users according to their interaction with the platform.

13. The computer-implemented system of claim 12, wherein the first registered user is the raffle initiator and the one or more second registered users are individuals seeking to obtain the raffle prize.

14. The computer-implemented system of claim 12, wherein managing the purchasing of tickets for the raffle comprises limiting the number of tickets available for purchase such that only a limited number of tickets are sold until funds substantively equivalent to the price of item have been raised, irrespective of the availability of additional time before the raffle end date.

15. The computer-implemented system of claim 12, further comprising managing the purchasing of tickets for the raffle by detecting when a first tranche of tickets sufficient to cover the price of the items have been sold, and subsequently causing a second tranche of tickets to be available for purchase until the raffle end date.

16. The computer-implemented system of claim 12, further comprising processing funds received in respect of the first tranche of tickets differently as compared with the funds received in respect of the second tranche tickets, where funds received in respect of the first tranche of tickets are automatically allocated to the first registered user and funds received in respect of the second tranche of tickets automatically distributed according to a predetermined profit distribution arrangement.

17. A computer-readable medium comprising computer instruction code that, when executed on a computer, causes one or more processors of the computer to perform the steps of:
receiving, by the one or more processors, details from a first registered user in relation to a proposed raffle, the details comprising:
a description of a prize in respect of which raffle tickets are offered for purchase by one or more second registered users; and
a price associated with the prize;
prompting, by the one or more processors, the first registered user to select:
a proposed raffle end date; and
one or more ticket distribution option(s) from a plurality of different ticket distribution options, each ticket distribution option involving a different number of tickets available for purchase prior to the proposed raffle end date;
associating, by the one or more processors, the one or more selected ticket distribution option(s) with the proposed raffle; and
based upon the item details and the selected ticket distribution option(s), automatically generating, by the one or more processors, a raffle interface accessible by the one or more second registered users, the interface providing details relating to the proposed raffle and the one or more raffle ticket purchasing option(s) based upon the ticket distribution option(s) selected by the first registered user; and
managing, by the one or more processors, the purchasing of tickets for the proposed raffle by the one or more second registered users according to the ticket distribution option(s) associated with the raffle;
wherein each raffle ticket purchasing option comprises a raffle ticket purchase price where the purchase price is automatically generated according to the ticket distribution option selected by the first registered user and/or the raffle end date; and
the interface comprises search functionality enabling the one or more registered users to conduct searches for raffles and goods and/or services that are available for purchase, wherein the one or more goods and/or services are advertised to the one or more second registered users according to their interaction with the platform.

18. (canceled)

19. The computer-readable medium of claim 17, wherein managing the purchasing of tickets for the raffle comprises limiting the number of tickets available for purchase such that only a limited of number of tickets are sold until funds substantially equivalent to the price of the item have been raised, irrespective of the availability of additional time before the raffle end date.

20. The computer-readable medium of claim 17, further comprising managing the purchasing of tickets for the raffle by detecting when a first tranche of tickets sufficient to cover the price of the item have been sold, and subsequently causing a second tranche of tickets to be made available for purchase until the raffle end date.

21. (canceled)

22. The computer-readable medium of claim 17, further comprising processing funds received in respect of the first tranche of tickets differently as compared with funds received in respect of the second tranche of tickets, where funds received in respect of the first tranche of tickets are automatically allocated to the first registered user and funds received in respect of the second tranche of tickets are automatically distributed according to a predetermined profit distribution.

23. (canceled)

24. (canceled)

25. (canceled)
